(19) United States
(12) Patent Application Publication
(10) Pub. No.: US 2009/0293112 A1
(43) Pub. Date: Nov. 26, 2009

(54) ON-LINE GENERATION AND AUTHENTICATION OF ITEMS

(76) Inventors: Stephen James Moore, Hampshire (GB); Marcus Maxwell Lawson, Hampshire (GB); Neil Richard Bradley Smith, West Sussex (GB); Francis Kirkman Fox, Hampshire (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/720,752

(22) PCT Filed: Dec. 2, 2004
(86) PCT No.: PCT/GB05/04629

§ 371 Date: Nov. 28, 2007

(30) Foreign Application Priority Data
Dec. 3, 2004 (GB) 0426617.7
Dec. 3, 2004 (GB) 0426618.5
Dec. 3, 2004 (GB) 0426623.5

(51) Int. Cl. H04L 29/06; H04L 9/32

(52) U.S. Cl. 726/9

(57) ABSTRACT

Value based tokens are generated for inclusion on a data carrier which may be applied to a media such as a coupon, bank note etc. The tokens are generated by a core system which communicates with application specific wrappers. The wrappers supply token parameters to the core that are specific to the application and the core generates the tokens, and stores them for later authentication. The core then encodes the tokens onto a data carrier under the control of the wrapper and distributes the tokens under the control of the wrapper. When a token is presented for validation, for example by a customer in a shop, the encoded data carrier is scanned and the token retrieved. It is passed back to the core by the wrapper for validation of its identification number and other parameters.

This invention relates to the generation and authentication of items, and is particularly, but not exclusively, concerned with the generation and authentication for redemption of items such as coupons on-line via the Internet or other computer network.

The use of coupons as a vehicle for attracting customers is very well known and well established. Typically a coupon offers a customer a discount on a product or service. The discount may be coupled to a requirement to redeem the coupon at a particular retail outlet and/or within a particular period.

It is estimated that over 5 billion coupons are distributed annually in the United Kingdom, and over 200 billion in the USA.

Coupons are printed and distributed through a variety of means including direct mail. The redemption rate varies: in the UK it is around 9% and in the US around 1.5%. Coupons typically offer a reduction in the price of an item, and the cost of providing the funding for coupons is split between the manufacturers and the retailers, with the manufacturers bearing the majority of the funding.

In recent years, Internet retailing has grown in popularity. Attempts have been made to extend the concept of coupons to Internet shopping but none has proved to be satisfactory. Attempts have been made also to provide coupons on-line that can be printed and redeemed in conventional shops, but these have not been reliable for a number of reasons.

An example of a known on-line coupon redemption system is disclosed in WO-A-99/57670 of Coolsavings.com Inc. Coupons are made available to customers on-line as electronic certificates and can be stored in a customer's personal database until they are redeemed or expire. Coupons can be used for a variety of purposes in addition to purchases of items, including the provision of proof of payment or proof of reservation. Coupons can be redeemed on-line or off-line. In order to redeem the coupons off-line they must first be printed for presentation to the retailer by the customer.

U.S. Pat. No. 6,321,208 and U.S. Pat. No. 6,339,099 both assigned to Brightstreet.com also discloses a system for electronic distribution of product redemption coupons. Packages of coupon data are stored at a central repository for downloading on demand to customer computers. Coupons may be printed by customers for redemption at retailers. The system disclosed can gather various data regarding the customer for subsequent analysis.

US 2001/0034635 of Winters discloses an on-line digital collectible award redemption and instant-win program. Customers receive coupons, referred to as Limited Edition Digital Objects (LEDOs), from on-line merchants and websites as a premium for making on-line purchases, visiting websites, taking surveys or other activities. LEDOs can be organised into an on-screen album for viewing and are presented as a small on-screen image. LEDOs can show pictures as well as play back audio and video and be used for interactive entertainment such as instant win contests.

U.S. Pat. No. 6,370,514 to Messner discloses a further method for marketing and redeeming vouchers on-line. In this patent, a centralised voucher server is used for processing transactions. Certificates may be purchased, either from a physical shop or on-line and the customer can select the merchants to which the certificate will apply. The voucher can also be used by merchants to offer coupons.

US 2002/0065720 of Carswell et al. discloses the management of on-line promotions by providing a coupon issuing server which allows users to download a single copy only of a coupon or other promotional item for subsequent redemption either on paper or on-line. This application addresses the problem of customers making multiple copies of coupons thereby enabling them to secure a far greater discount on items than was intended by the promoter.

A further example of an on-line coupon redemption system is disclosed in US 2002/0138348 of Narayan et al. This application offers a server-side solution enabling customers to access coupons via the Internet or a POS device. Coupons may be stored by a customer at a participating portal for later redemption at a retailer.

U.S. Pat. No. 6,584,448 assigned to Catalina Marketing International, Inc discloses a system for electronic redemption of vouchers. The vouchers comprise a data structure including data representative of a version number of the coupon, data representative of a party capable of redeeming the coupon and data representative of a serial number unique to the coupon and identifying the coupon.

U.S. Pat. No. 6,505,773 assigned to International Business Machines Corp. discloses a system for issuing and redeeming authenticated coupons. Advertisements are displayed to customers before coupons are redeemed to assure the coupon issuer that its targeted customers are receiving advertisements. Coupons are issued as smart cards to avoid the need for paper coupons. The coupons on the card are digitally designed further to increase security.

US 2002/0178060 of Sheehan discloses a further system for issuing and redeeming coupons on-line. In this disclosure, the coupons are paperless and may be embedded in a video or audio program or may be transmitted via a separate signal. Coupons generated by this system are not confined to the internet but may be distributed or redeemed using other digital media such as digital television or radio.

Similar techniques to those discussed above are used in US 2002/0169623 of Call et al. to create even tickets on-line. These tickets may contain barcodes containing unique authentication information. The barcode may be duplicated to ensure that the ticket may still be used if one of the barcodes becomes damaged and cannot be read. The authentication information is also copied to a database and is used to authenticate the ticket when it is presented by comparing the barcode in the ticket with the stored data. Tickets may contain transparent images that when photocopied become opaque and prevent a ticket from being redeemed.

GB 2406690 of Neopost Industrie SA discloses a system in which authentication information is stored in a data matrix. A data matrix is a 2-dimensional bar code. The data is cryptographically encoded in the data matrix and may be read by a processing unit which checks the validity of the item and transmits a message back to a presentation station indicating whether or not the item is valid. The data matrix may carry a digital signature. We have appreciated that the system described in this document is impractical as the data that is required to be stored in the data matrix exceeds the capacity of an acceptably sized data matrix. Even if the data matrix could be made physically large enough to carry the amount of data required it would not be rugged enough to be read reliably. As coupons are used by customers and will often be folded or crumpled, a rugged, easy to read system is essential if the system is to be viable. Moreover, the system disclosed in GB 2 406 690 is only suitable for use in a closed environment in which only a single type of token is used and which is only to be read at a single verification point.

It will be appreciated from the foregoing discussion that many proposals have been made for the on-line generation and redemption of coupons. In some cases, for example the Coolsaving.com Inc system, commercial products have been put on the market. The Coolsavings.com Inc product is available on the internet at Coolsavings.com. Some of the prior systems mentioned above address security issues, for example the use of Smart Cards in U.S. Pat. No. 6,505,773 and the use and comparison of barcodes in US 2002/0169623. However, a number of technical problems remain which are not addressed by any of the art known to the applicant. In particular, coupons which can be printed at home by the customer for redemption at shops have failed to gain widespread acceptance for a number of reasons. First, it is difficult to control the number of coupons issued to customers and therefore difficult to plan a promotion budget. The system disclosed in US 2002/0065720 goes some way to addressing this problem but is practically difficult to implement as it relies on knowing the identity of customer computers. Most customers will log on via an ISP (Internet Service Provider) and will have a different IP address for each session making identification very difficult.

None of these prior proposals is satisfactory to bridge the gap between online shopping and terrestrial shopping.

A problem exists also with possible fraud by customers. As coupons are downloaded to customers' individual computers, there is a risk that customers will alter the coupons, for example by changing the amount for which they can be redeemed (their face value). This type of manipulation is relatively simple using commercially available graphics packages.

A further problem exists in the printing of coupons. Most domestic computer owners have relatively low resolution printers and can often print only in black or white. This can lead to poor quality coupons being printed, which look to retailers like photocopies and are therefore rejected. Poor quality copies could only be acceptable if the retailer was assured that they were genuine.

A further problem also exists with all the known approaches described above, in that any information that is printed on a coupon is very rigid and can only be used for a very limited purpose, for example to check authenticity. We have appreciated that it is desirable to read data from a coupon for a variety of different reasons. Authentication of a unique coupon may only be one of these reasons.

We have appreciated that identification indicia such as disclosed, from example in GB 2406690 may be used in a wide variety of applications, such as tokens for redemption in supermarkets, personal money, encoding medical prescriptions and many other uses. We have further appreciated the desirability of a validation system that can validate information stored on identification indicia regardless of the application and which can generate the indicia for application.

The present invention aims to address the aforementioned problems and provides a system for generating and authenticating tokens representing value, comprising: a core system for generating and authenticating tokens; and a plurality of application specific wrappers communicating with the core system each for providing the core system with application specific data relating to tokens generated by the core, whereby the core produces tokens which have a content controlled by the wrapper; and wherein the core comprises: a token generator responsive to one of the wrappers for generating value based tokens having parameters at least partially determined by the wrapper; a store for storing the value based tokens; an encoder for encoding the value based tokens onto a data carrier, the encoder being responsive to the wrapper to determine the encoding applied by the encoder; and a token deliverer for delivering the generated tokens electronically to third parties via a delivery channel.

Preferably the delivery channel is selected by a wrapper. The token generator creates a token in response to a request from the wrapper and can also modify the status of a token in response to a request from the wrapper. A modified token status is then stored in the store.

Preferably, the encoder retrieves a token from the store for encoding according to a format specified by the wrapper. The data carrier may be a 2-dimensional bar code for example a data matrix or some other standard for example an RFID device.

Preferably the token generator comprises a token manager, which receives a token type from the wrapper, generates a token identification number, and creates the token in the store. The token manager may receive further token attributes from the wrapper. The further token attributes may be at least one of a PIN code, data to be carried with the token, token start date, token end date, token status, and the number of times the token can be redeemed.

Preferably the token manager generates an internal token key for each token, the internal token key being used to reference the token identification number (TIN) when the TIN is received from a remote location for authentication. Preferably the token manager retrieves a security function for the token type and applies the security function to the token prior to storage.

The token manager may modify a token by receiving token attributes from the wrapper, checking the status of the token and updating the token only if the status is acceptable.

The encoder may be part of the token manager and may function by receiving a request from the wrapper including the token identification number and the type of data carrier, wherein the encoder returns the data carrier encoded with the token to the wrapper.

Preferably, the core comprises a token authenticator for authenticating the validity of tokens received from the wrapper. The authenticator receives the token TIN from the wrapper, confirms that the token exists in the store and authenticates the token if the token is stored as valid. Where the token has a start and end date and authenticator further validates start and end dates. Where the token has a redemption count indicating the number of times it can be redeemed the authenticator validates the token only if the redemption count has not been exceeded. Preferably, the authenticator retrieves the security profile for the token and validates the security content of the token.

Preferably the core further comprises a redemption component for redeeming authenticated tokens, the redemption component changing the status of a token in the store to indicate that it has been redeemed. The redemption status may be changed by incrementing a redemption count.

The token is preferably a value based token having a header including a token identification number, a payload and a security section. The payload may include an additional payload comprising a reference to data stored in the store which is provided on authentication of the token.

Embodiments of the invention will now be described, with reference to the accompanying drawings, in which:

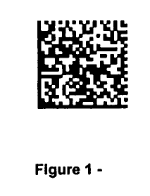

FIG. 1 is a view of a data matrix;

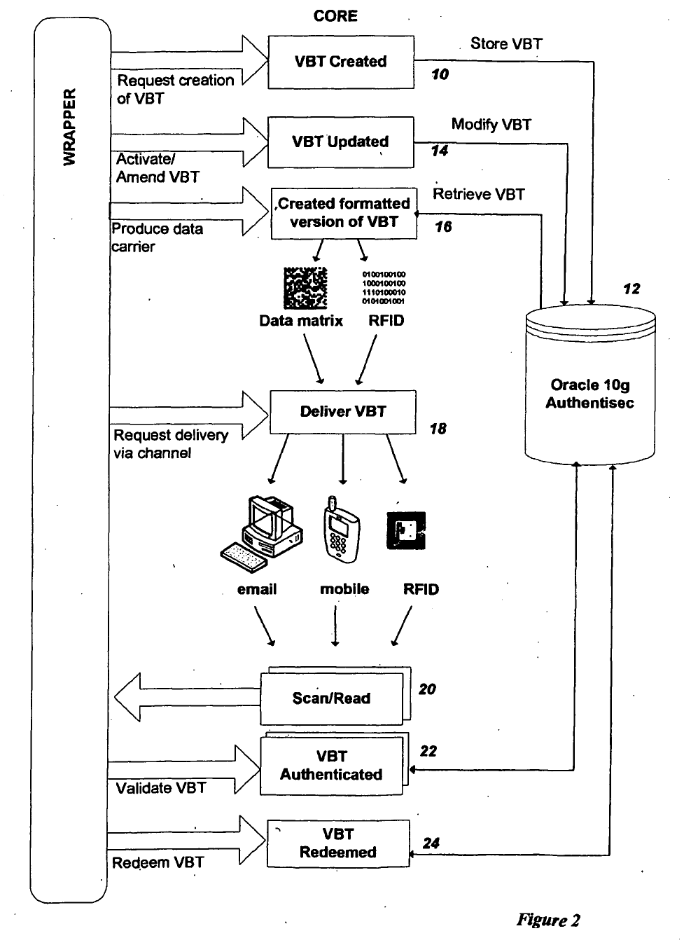

FIG. 2 is a schematic diagram of the core and wrapper of a system embodying the present invention;

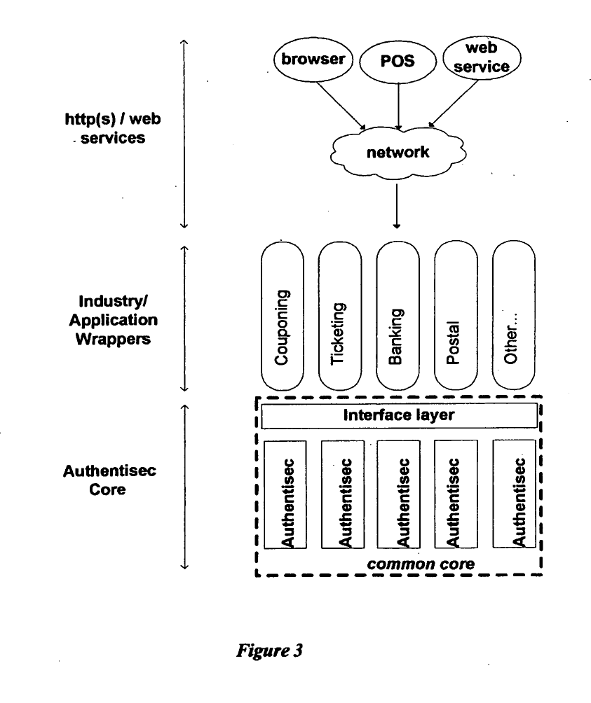

FIG. 3 shows how the core of FIG. 2 may be used with a plurality of different application wrappers;

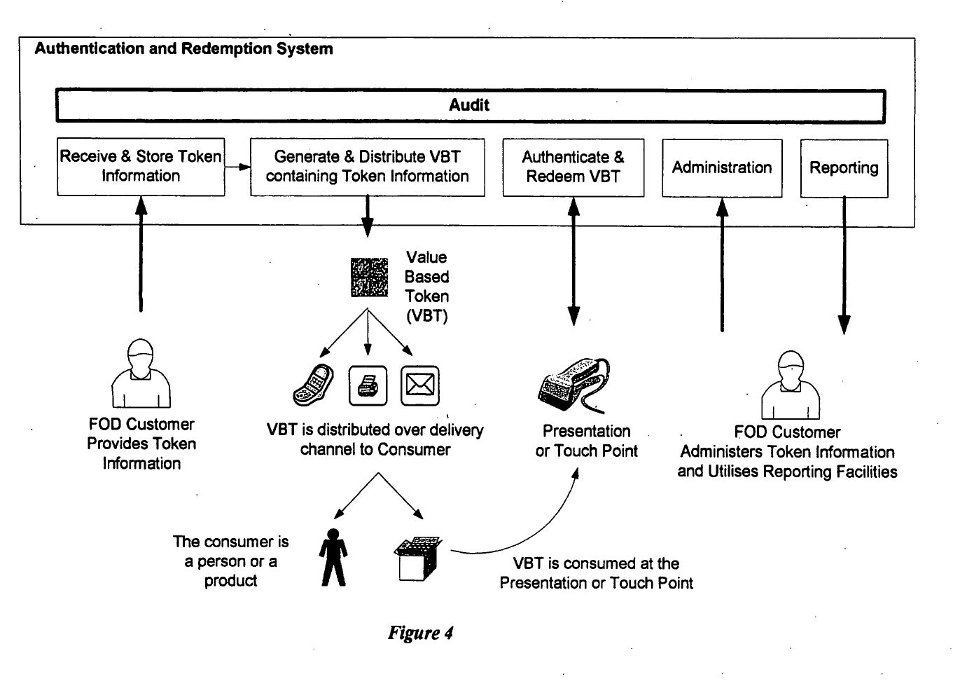

FIG. 4 is a schematic representation of the functionality of the system;

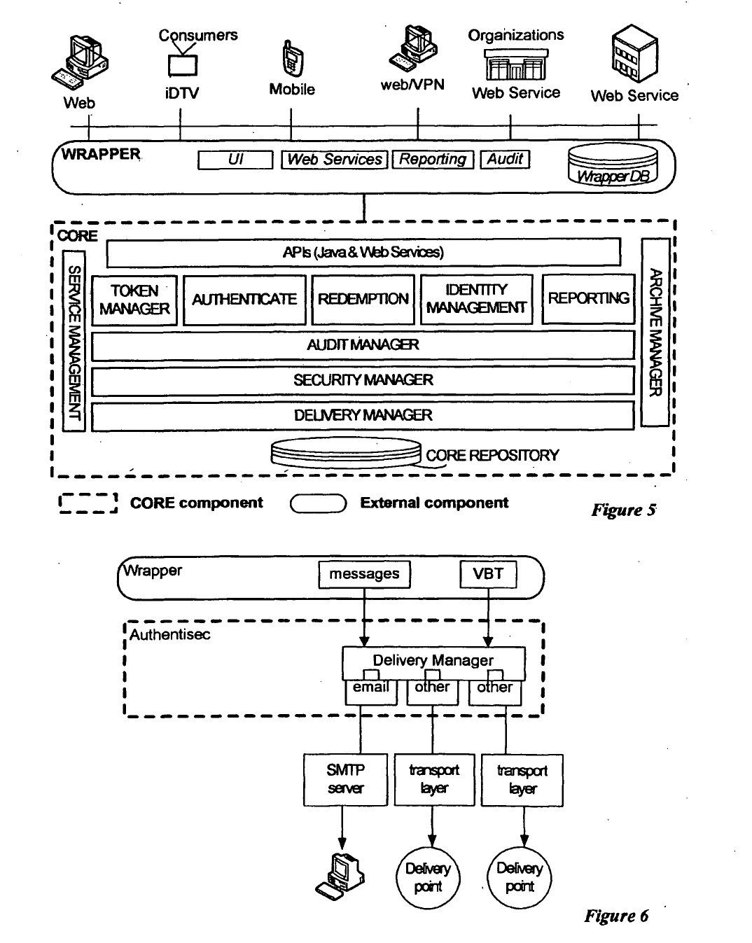

FIG. 5 is a representation of the software components of the core of the system of FIG. 2 providing the functionality of FIG. 4;

FIG. 6 is a representation of the functionality of the delivery manager of FIG. 5;

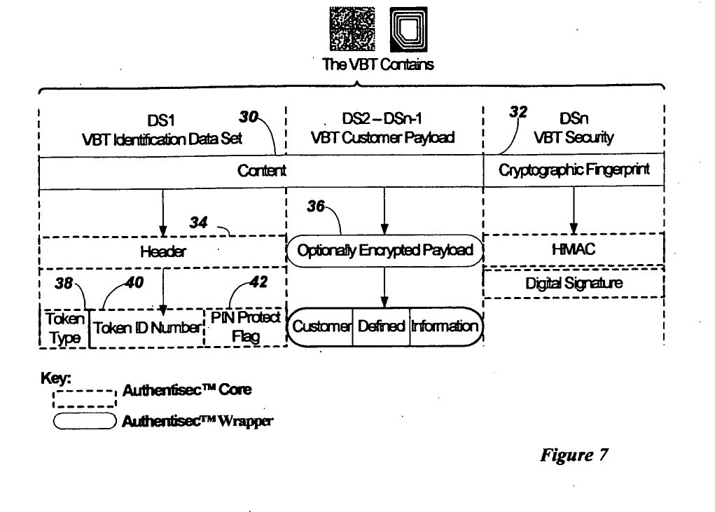

FIG. 7 shows the structure of a value based token embodying the invention;

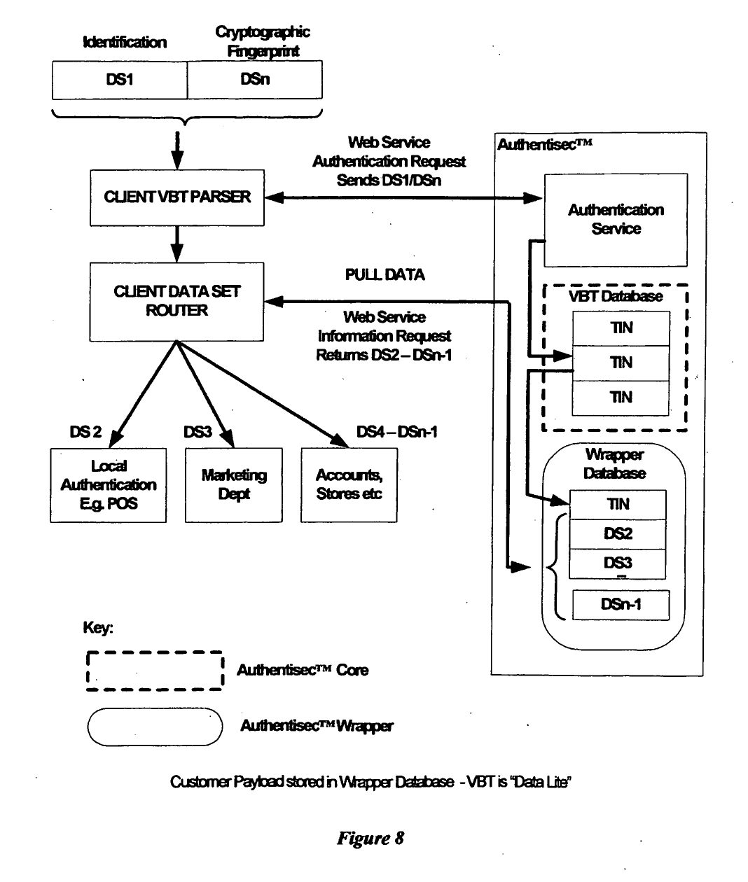

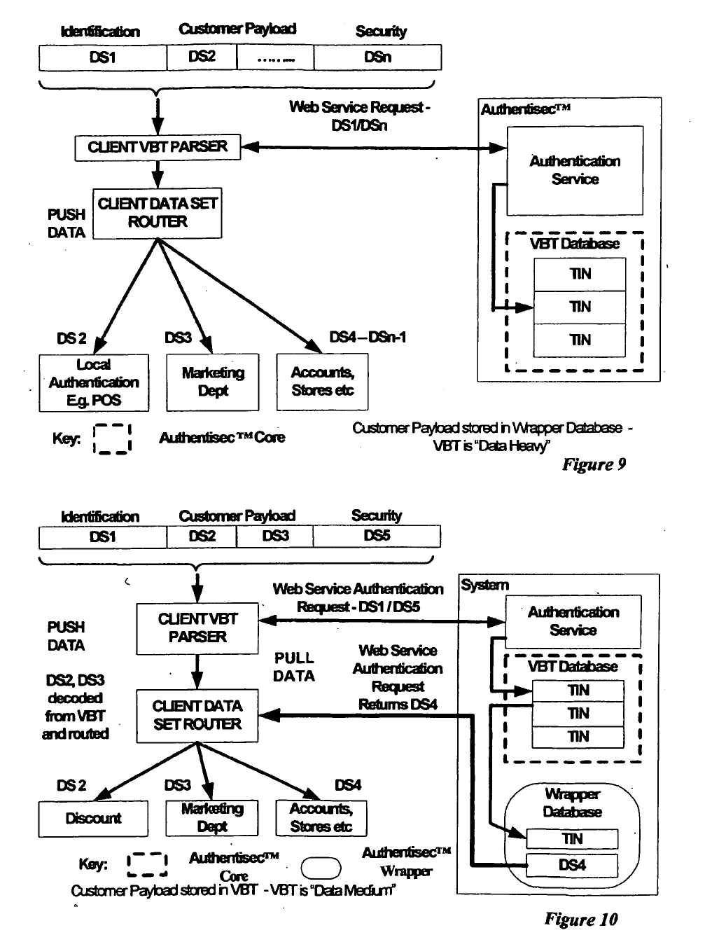

FIGS. 8 and 9 show, respectively, embodiments using data lite and data heavy value based tokens;

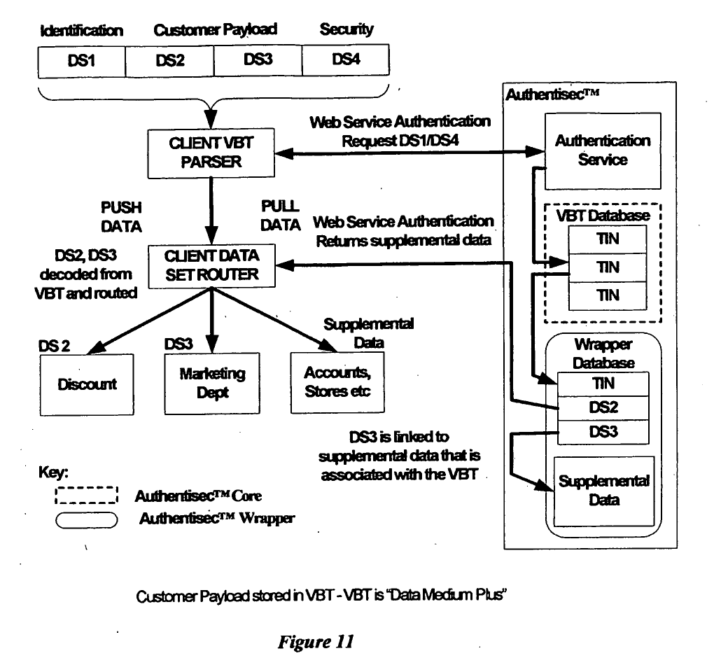

FIGS. 10 and 11, respectively, show VBTs having intermediate amounts of data in the token;

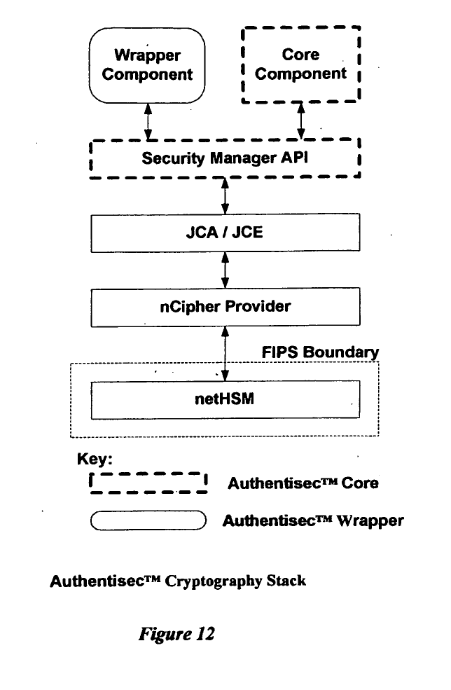

FIG. 12 is a schematic diagram showing cryptographic functions;

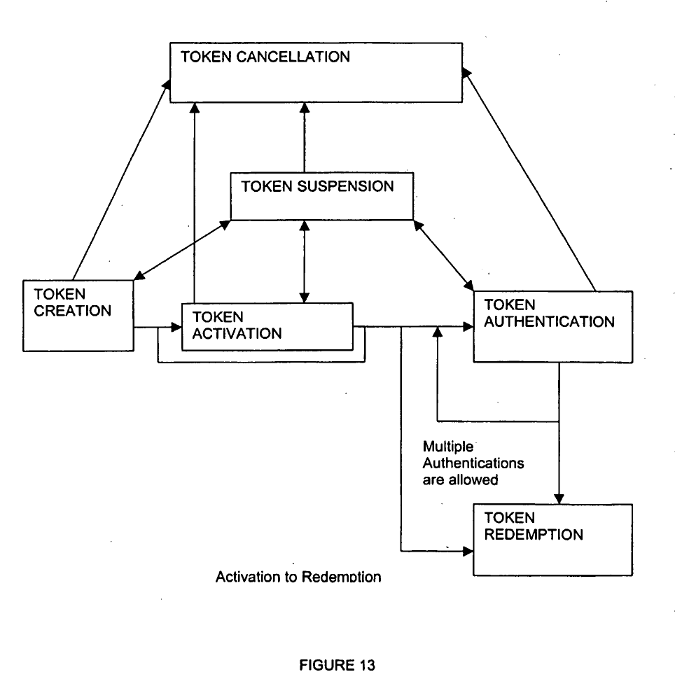

FIG. 13; is a schematic diagram showing the life cycle of a value based token;

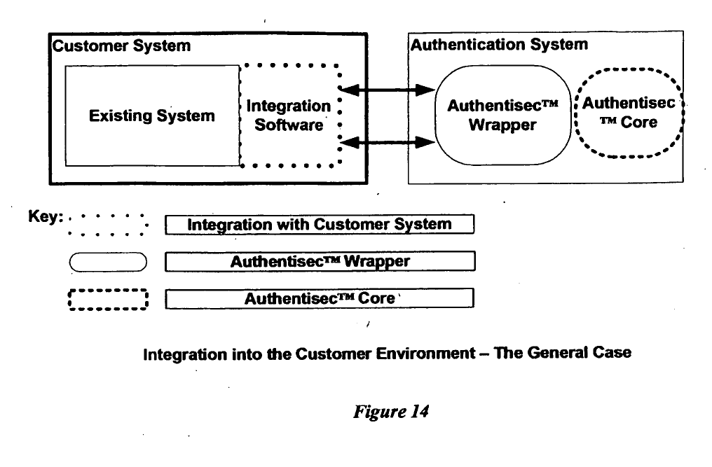

FIG. 14 shows how a system embodying the present invention may be integrated into existing customer systems;

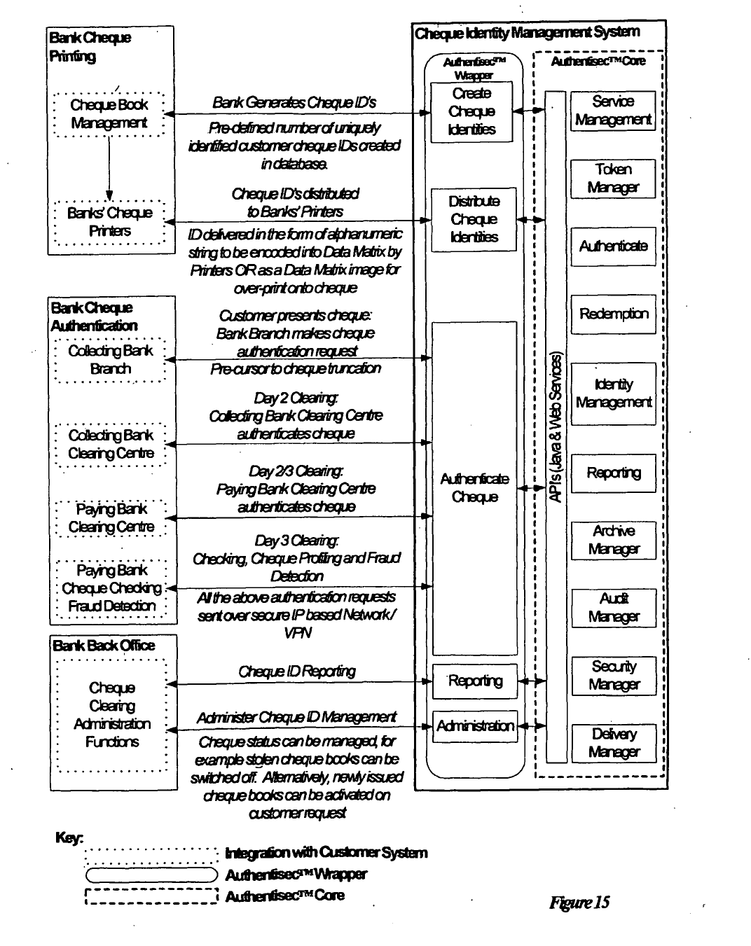

FIG. 15 is a schematic view of how an embodiment of the present invention may be used to authenticate cheques;

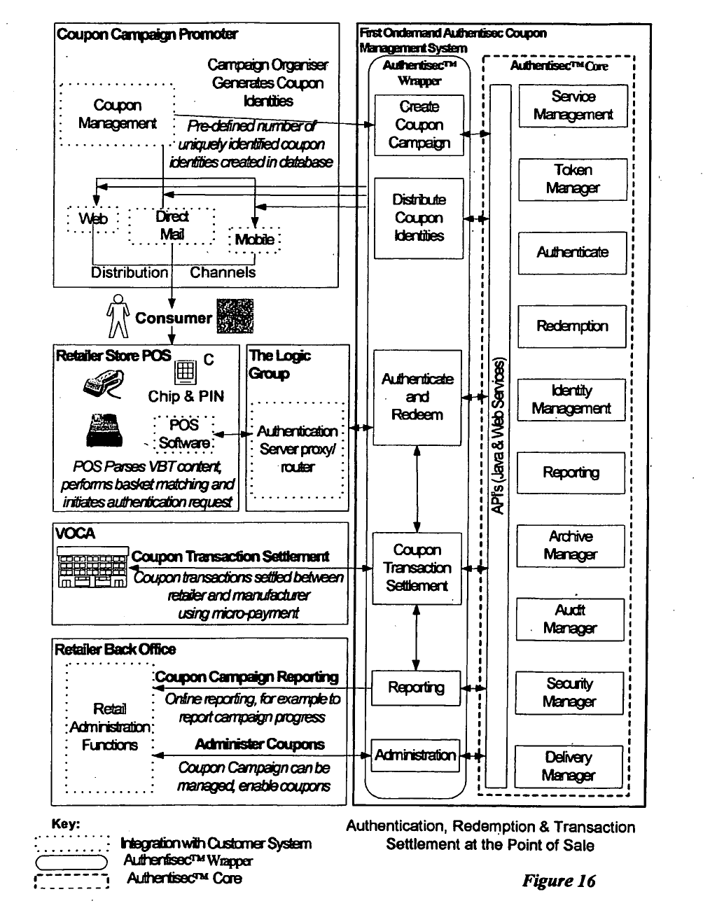

FIG. 16 is a schematic view of how an embodiment of the present invention may be used to authenticate coupons;

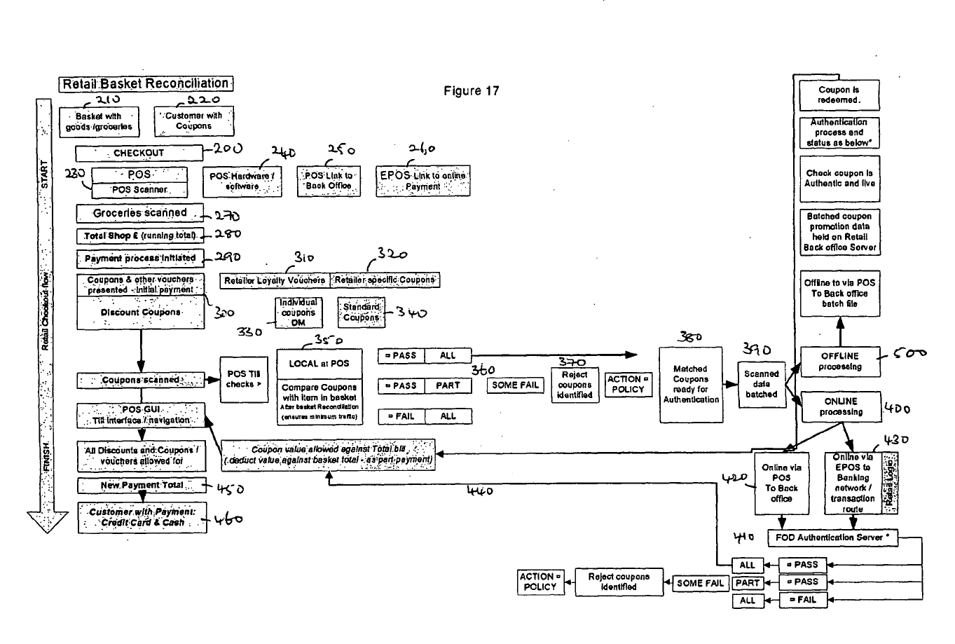

FIG. 17 is a coupon process flow diagram; and

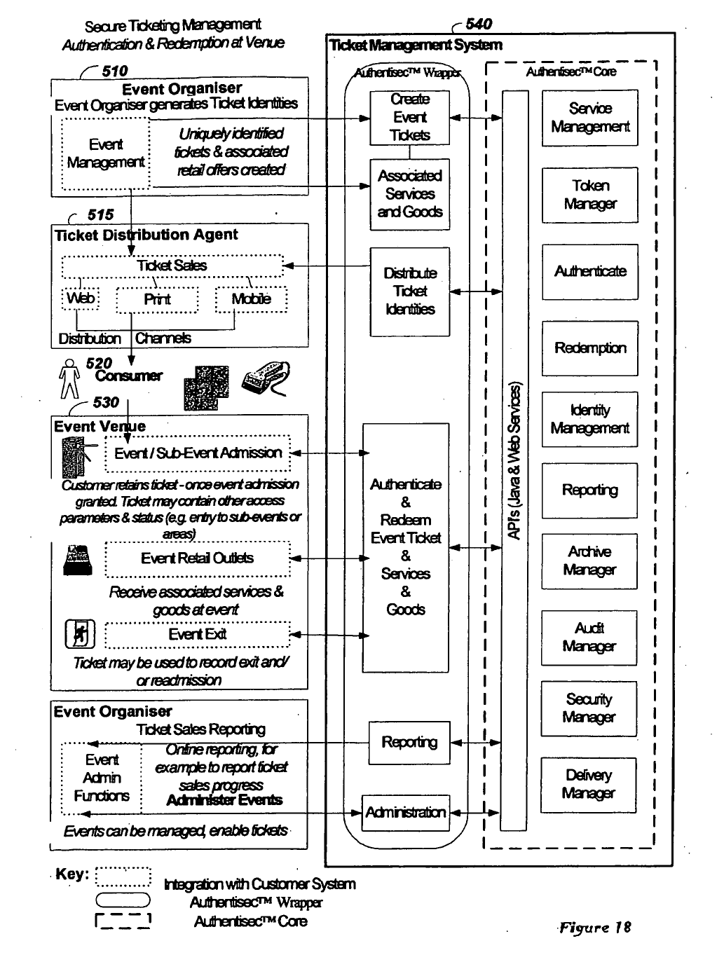

FIG. 18 is a schematic diagram showing how embodiments of the invention may be used in a ticket authentication system.

The system to be described provides a secure, web service based, authentication system for printed and other media types using data carriers such as Data Matrices and RFID. The system has a core generic part, which includes components that support generic functional requirements. The core components are extended on an application by application, or customer-by-customer to support specific industry requirements. These specific extensions are referred to as “wrappers”. The system is not limited to the Internet or World Wide Web but may be implemented on any type of network, for example a company private network. In many applications, embodiments of the invention will interface with existing networks of a user or set of users.

The system to be described may be used in a variety of different applications. The following are given as examples only.

Couponing: Adding a value-based token (discussed below) to a retail coupon. This enables the coupon to be validated at the point of sale preventing mal-redemption (fraudulent redemption) and mis-redemption (redeeming coupons for products not being purchased).

Banking: Adding a value-based token to cheques (for example, when a cheque is printed). This can then be used within the banking environment to validate cheque details during the clearing process to reduce fraud. Alternatively, value-based tokens can be used to create personalised money, which may be redeemed by the user on a one-off basis.
Ticketing: Creating tickets as value-based tokens and delivering them via various channels: postal, email, mobile etc. This allows secure authentication and redemption of tickets at the point they are presented.

It is stressed that these are only a few of the many applications of the embodiments to be described and are given by way of example only. The concept of a value-based token (VBT) is fundamental to the design of the solution and is discussed here briefly. A fuller description is given below. A VBT is a mechanism that allows a unique entity to be created, printed (or delivered via another channel) and subsequently authenticated. All VBTs have a unique identity, the ability to store data and security features to prevent their content and structure being amended maliciously. For example, a VBT generated for a money-off coupon may contain a unique token number, details about the product the coupon can be used against and a message authentication code (MAC) used to identify if a token has been altered.

The preferred data carrier for the VBT is the Data Matrix (DMx). However, other data carriers may be used depending on the nature of the VBT and the data to be carried, and the geographical region in which the solution is to be implemented. The nature of the data carrier is described in detail below. Data Matrix is an encoding standard used to produce a 2-D barcode such as the one shown in FIG. 1. In essence the data matrix is the transport mechanism for the VBT. It can be included in a document, on some other form of printed media or could even be applied to a product itself. At some point in the VBTs life it will be read (scanned) and then authenticated and/or redeemed by the system.

A Data Matrix encodes information digitally in the form of a checkerboard pattern of on/off. Data Matrix is defined by ISO standard, ISO/IEC16022— International Symbology Specification, Data Matrix.

It is possible, in some embodiments of the invention, that the VBT will never be printed, for example if it remains in electronic form. In such a case, the VBT may not need to be encoded on a data carrier.

FIG. 2 provides an overview of the interaction between a wrapper (industry implementation) and the core. The core includes a database, for example an Oracle 10g database which holds data to be included in the VBT and data which is related to data held in the VBT, as discussed below. The core is responsible for creation, updating and delivery of VBTs as well as the creation of formatted versions of VBT for inclusion on the selected data carrier. The core is also responsible for the processing of scanned data carriers to authenticate them and to update the database to show that a given VBT has been redeemed. The wrapper holds information that is specific to an application so that, for example, where the data carrier is applied to a coupon, the wrapper will hold information that is specific to that application, such as the data structure of the VBT, the type of encryption used and the data carrier into which the VBT is to be formatted. This approach makes is simple to adapt the system to new applications for the VBT.

The various functions of the core shown in FIG. 2 will now be described in more detail.

Creation 10: During token creation, the core creates a unique identity for the VBT and stores it in the token repository (database 12). A VBT will carry data relevant to its application although it is not a data store in itself. For example, a VBT used to secure a cheque may contain the payee, account and amount. The wrapper is responsible for passing all application specific data to the core. Each type of VBT will have specific security requirements defined in a security policy. For example, a simple voucher may only need a message authentication code to prevent data being changed whereas a bank cheque may require encryption and a digital signature. The core will apply these security features automatically during creation. The structure of the VBT is discussed below.

Update 14: A wrapper may need to update a token during its life, usually to change its status. The core allows updates providing they do not violate the rules defined for the token type, e.g. a wrapper can change the token status from ‘created’ to ‘active’.

Format for data carrier 16: A wrapper can request that a VBT is built for a particular data carrier, for example a Data Matrix or RFID. The core chooses the appropriate software application for the data carrier and uses it to construct a VBT of this type. New providers can be plugged in to the core and configured for use via an administration interface.

Deliver 18: The core allows a wrapper to send tokens via supported channels. Messages sent via the core can use generic XSLT templates to format messages. Alternatively, a wrapper can construct a message itself and simply send it via the core. Messages may be delivered via email. Additional channels may require access to third party messaging gateways for example, to send SMS messages.

Read VBT 20: A VBT will be scanned/read at the point of use, for example a bank or a retail outlet. The content of the VBT can be used locally if required. However, to authenticate or redeem the VBT the content will be securely sent via the wrapper, e.g. a web service call. The wrapper can apply custom validation, business logic before using the core to authenticate and/or redeem the VBT.

Authenticate 22: The wrapper will pass the entire content of the VBT to the core for authentication. During this process the VBTs security features are used to validate its authenticity, i.e. PIN, MAC and signature. Where a VBT contains encrypted data the core will unencrypt and return the clear text to the wrapper where additional processing can be performed.

Redeem 24: The wrapper will pass the entire content of the VBT to the core for redemption. The VBT will be checked by the core to ensure it is valid and if successful will update the VBT to a redeemed status. VBTs will normally be redeemed only once; however the core will allow tokens to be configured to allow multi-redemption of a single VBT. This may be required in some applications, where, for example, the VBT relates to a multiple entrance pass for a venue.

A typical deployment will include the core extended with a wrapper, which is a customisation for a specific application). FIG. 3 shows several deployments, each with their own wrapper. The wrapper may extend the core to implement additional data requirements, additional validation/business logic, customize the look & feel and provide a user web portal. In FIG. 3 examples of wrappers for couponing, ticketing, banking and postal applications are shown.

FIG. 4 shows the outline functionality of the system. There are five basic modules which are described in detail in relation to FIG. 5 below: Audit, Receive and Store Token Information; Generate and Distribute Value-based-token (VBT) containing Token Information; Authenticate and Redeem VBT; Administration; and Reporting. The receive and store token information module receives token information from customers who provide details of the data that is to be included in the token. For example if the token represented a money-off token, the identity of the token as a money-off coupon, and the token value, the product to which it relates and other parameters are supplied by the customer via a wrapper for that token type, as is described below. The generate and distribute module takes the token information and forms it into a value-based-token having a structure described below and then encodes the VBT onto a data carrier. The data carrier is then distributed to consumers over any convenient delivery channel such as, but not limited to, the postal services, email, fax, commercial print works and web based distribution. The consumer is a person or even a product. The VBT may be applied to a coupon or the like that a person can redeem or may be applied to a product such a labeling or packaging. The authenticate and redeem module is responsible for verification of the authenticity of a VBT bearing data carrier when it is presented. The data carrier will be scanned and the encoded VBT recovered and verified by the system in a manner to be described. Finally the administration and reporting modules allow customers to interact with the system to provide them with selected information about the generation, authentication, and redemption of tokens by the system in accordance with their level of permissions.

FIG. 5 illustrates the software components that comprise the core. The core supports Internet and Intranet access via a browser which is also used to access the core administration interface and web service calls to APIs. Components are built using a J2EE development framework.

The following processes form part of the core solution. Each wrapper may use all or a subset of these processes to deliver the most appropriate solution

### User Account Creation

### User Account Maintenance

### Login/Logout and Session Management

Key management

### Token Creation

### Token Maintenance

Token Generation (format VBT for data carrier, e.g. data matrix)

### Token Encryption

### Multi-channel Token Delivery

### Token Authentication

### Token Redemption

### Multiple Token Redemption

### Token Batch Creation and Management

Unique Token ID generation

### Token History Reporting

### Audit Reporting

### Token Manager

The Token Manager component supports the creation and maintenance of VBTs within the core repository. It does not include any authentication or redemption functionality to provide additional security and deployment options. The token manager provides for creation of a unique entry in the core repository representing a VBT; maintenance of a history of all token events, e.g. creation, update etc. The token manager can specify an optional free text payload that will be contained within in the generated token. For example, this payload would be written to a data matrix or written to an RFID chip. This payload is referred to as the embedded payload. The token manager can also specify an optional free text payload that is stored in the database. This payload is referred to as the additional payload. This payload will not be included when the token is generated. Additional payloads can be retrieved when a token is authenticated or redeemed. The token manager controls updating of a token's additional payload. A token can only have one additional and one embedded payload. A token's embedded payload cannot be updated unless it is in created status. If it has any another status it may already have been delivered, e.g. printed, and the delivered content cannot be amended. The token manager can specify an optional pin/password to secure a token. It is also responsible for activation and cancellation of tokens. Prior to activation any attempt to authenticate or redeem a token will fail. A token is only valid between its start and end dates. These dates include a time element. The token manager can create tokens for different data carriers.

A token's security features, such as whether it contains a digital signature, are defined in a security policy. The following combinations of token, wrapper (payload) and security data may be supported:

### Token

### Token+Payload

### Token+Payload+MAC

### Token+Payload+Digital Signature

The payload can be clear text or encrypted depending on the application. Every token event (creation, update etc) can be audited and a token batch can be created and used as a logical grouping of tokens. A batch includes a meaningful name. A token may be assigned to an existing batch.

The core supports an extensible token lifecycle so that new statuses and the valid transitions between statuses can be defined. The token manager can also redeliver an existing token, for example, if the original has been lost.

The operation of the token manager will be better understood from the following use cases.

| | |
|---|---|
| Use Case Name: | Create Token |
| Actor/Role: | Wrapper |
| Description: | Create VBT entries within the repository |
| Pre-Conditions | Wrapper is authenticated and authorised to use the |
| | service. |
| | Where a batch is specified the batch must already be |
| | created. |

### Flow:

1. Wrapper sends token details to the Token Manager component. As a minimum the token type is required. Other optional attributes include:

| | |
|---|---|
| PIN | Security code required when using token. |
| Payloads | Data to be carried with the token. |
| Start date | Date from which the token can be used. |
| End date | Date at which the token expires. |
| Status | Status to be assigned after creation. |
| Redemption Limit | Max times VBT can be redeemed (default 1) |
| Batch Identifier | Batch token should be assigned to. |

2. Validate that the token type is available for the current service.
3. Validate token details. The PIN preferably has an alphanumeric value up to 30 characters in length. If an additional payload has been specified, i.e. it will be held in the database, the token type must be validated to confirm this type of payload is supported. If a status other than ‘created’ has been specified it must be a valid transition from ‘created. The batch must exist.
4. Generate token identification number [TIN]. This will be generated via the Security Manager that provides random number generation. The TIN may, for example be of fixed length such as 16 digit numbers for the TIN. However it is preferred that the TIN length is configurable as this further increase the flexibility of the system.
5. Generate token key. This value is also generated using the Security Manager's random number generator. This is a unique internal key for the token which will be used when referencing the token externally, e.g. from an email. As the key is not embedded within the token it is more difficult for malicious users to obtain.
6. Retrieve the security profile for this service/token. This will determine how the token should be constructed. The security profile will include:

| | |
|---|---|
| Hash | Hash/HMAC function used for MAC |
| Signature | Cipher used for digital signature |
| Encryption | Cipher used for encryption |
| Method | Describes which security features to use. |

7. Apply security policy to generate VBT string. If required, calculate the message digest of the token header and payload using the Security Manager. One suitable standard is HMAC-SHA256.
If required, calculate the digital signature of the token using the Security Manager. One suitable standard is RSA-SHA256.
8. Create token and its payload(s) within the repository.
9. Create a token history record containing all the token details.
10. Write an audit record of type ‘TOKEN_CREATION’ for the event.
11. Return the TIN to the wrapper

| | |
|---|---|
| Use Case Name: | Update Token |
| Actor/Role: | Wrapper |
| Description: | Amend VBT details (e.g. setting status to ‘active’) |
| Pre-Conditions: | Wrapper is authenticated and authorised to use the |
| | service. |
| | Where a batch is specified the batch must already be |
| | created. |

### Flow:

1. Wrapper sends token details to the Token Manager component. In addition to the TIN the attributes may include:

| | |
|---|---|
| PIN | Security code required when using token. |
| Payloads | Data to be carried with the token. |
| Start date | Date from which the token can be used. |
| End date | Date at which the token expires. |
| Status | Status to be assigned after creation. |
| Redemption Limit | Max times VBT can be redeemed (default 1) |
| Batch Identifier | Batch token should be assigned to. |

2. In addition to the validation checks performed for these attributes in the ‘create token’ use-case the following checks should be performed. The embedded payload can only be updated if the token has a status of created. If a new status is specified it must be a valid and current transition as defined in the Token Management component.
3. Re-apply security policy to generate VBT string.
4. Update the token and payload (if amended) within the repository.
5. Create a token history entry in the repository.
6. Write an audit record of type ‘TOKEN_UPDATE’.

| | |
|---|---|
| Use Case Name: | Generate Token |
| Actor/Role: | Wrapper |
| Description: | Generate a VBT for specific data carrier (e.g. data |
| | matrix) |
| Pre-Conditions: | Wrapper is authenticated and authorised to use the |
| | service |

### Flow:

1. Wrapper sends request to the Token Manager. The TIN will be specified to identify the token. The wrapper may also use the attribute: Data Carrier. In a preferred embodiment, two data carriers are supported: [symbol]
Text: Simply returns the raw VBT string. [symbol]
Data Matrix: Encodes the VBT string using data matrix symbology.

### 2. Validate the TIN and Data Carrier.

3. Retrieve the provider (class responsible for encoding the VBT string) for the data carrier.
4. Encode the VBT string for the requested data carrier. For example, where the data carrier is data matrix a 2-D barcode will be generated using the data matrix image or font generator.
5. Return encoded VBT to the wrapper.
6. Write an audit record of type ‘TOKEN_GENERATE’.

| | |
|---|---|
| Use Case Name: | Create Batch |
| Actor/Role: | Wrapper |
| Description: | Create a batch (logical container for VBTs) |
| Pre-Conditions: | Wrapper is authenticated and authorised to use the |
| | service. |

### Flow:

1. Wrapper sends request to the Token Manager component. An optional batch description can be specified.
2. A batch is created with a unique identifier.
3. Return batch identifier to the wrapper.

### Token Manager API

The following Java API's will be exposed to wrapper modules. The APIs are built to allow new commands to be added as required without altering any existing API calls.

createToken—Create a token as per the use-case described above.
updateToken—Update an existing token subject to the use-case describes above.
generateToken—Encode the token into a Data Matrix or other token formats such as RFID.
createBatch—Creates a new batch in the token repository and returns its ID to the calling module.

### Authenticate

The authentication component is responsible for authentication of tokens when they are read or scanned.

If a token has been signed the signature must be validated during authentication. An invalid signature will result in authentication failure. If a token contains a MAC this must be validated during authentication. An invalid MAC will result in authentication failure. During authentication a check is performed to confirm that the token exists within the repository. A missing token will result in authentication failure. During authentication the token's start and end date must be checked together with its status. When a status is defined it will be assigned a flag that identifies whether it will cause authentication to succeed or fail. For example, a status of ‘created’ may cause authentication to fail and a status of ‘active’ may result in success. If a token has been secured with a PIN, the PIN should be supplied and checked as part of the authentication process. If the supplied PIN does not match the original value the authentication process will fail.

On successful authentication or redemption the additional payload is returned (if requested).

All authentication requests successful or otherwise should be audited.

The manner in which the authentication component operates will be understood better from the following use cases.

| | |
|---|---|
| Use Case Name: | Authenticate Token |
| Actor/Role: | Wrapper/Web Service |
| Description: | Verify Token Details |
| Pre-Conditions: | Actor is authenticated and authorised to use the |
| | service. |

### Flow:

1. Wrapper sends token content to the Authenticate component. It also specifies whether the additional content should be returned on successful authentication and any PIN details specified by the user.
2. Retrieve the security profile for this service/token type using the service management component. This must be the policy in place at the time the token was created.
3. If a PIN is required to use the token the PIN value supplied must be processed to ensure it matches the PIN digest stored in the repository.
4. If the security policy specifies a digital signature use the Security Manager to validate the signature. If the signature is invalid return an authentication failure status.
5. If the security policy specifies a hashing algorithm use the Security Manager to validate the message digest. If the message digest is invalid return an authentication failure status.
6. Confirm the token exists in the repository and that its status contains a valid ‘authenticate’ flag.
7. Validate the tokens start and end dates.
8. If a token's redemption count must be less than its redemption limit (the maximum number of times it can be redeemed).
9. If all the above steps have passed the validation process returns a valid status to the actor and the additional payload (if requested)
10. Write an audit record of type ‘TOKEN_AUTHENICATE’.

### Authentication API

The following Java APIs support the authentication use-case above. Although a default authentication Web Service is part of the core most wrappers extend the authentication process. In this case the Java APIs can be used to support the requirements of their redemption process.

authenticateToken—using the security features on the token, this API verifies that the token is genuine and has not been tampered with.
authenticatePIN—compare the PIN stored against a token with a user supplied value.

### Authentication Web Services

AuthenticateToken—this service supports the authentication process defined in the above use-case. If the service consumer requests the token's additional payload it is returned only on successful authentication.

### Redemption

This component is concerned with redeeming tokens after they have been authenticated.

Before redeeming a token it must pass all token authentication tests. A token can only be redeemed if it has a status is flagged as ‘redeemable’. For example, the token statuses ‘created’, pending’, ‘approved’ and ‘redeemed’ may be defined and tokens may only be redeemed in they have a status of ‘approved’.

A token can be redeemed more than once, with the maximum number of times a token can be used being defined for a token at its creation. By default a token can only be redeemed once.

All attempts to redeem a token are written to an audit log, and when successfully redeemed a token's status is updated to ‘REDEEMED’ (or to a specific status).

The operation of the redemption component is further explained by the following use case.

| | |
|---|---|
| Use Case Name: | Redeem Token |
| Actor/Role | Wrapper/Web Service |
| Description: | Amend token details (e.g. setting status to ‘active’) |
| Pre-Conditions: | Actor is authenticated and authorised to use the service |

### Flow:

1. Actor sends token content to the redemption service including any PIN details specified by the user.
2. Token is fully authenticated as per the Authenticate Token use-case. If authentication fails a failure response is returned to the Actor.
3. Token status is updated to ‘redeemed’ (or to whatever status the actor has requested, subject to transition rules).
4. Increment the redemption count.
5. Write the transaction to the audit log.
6. Return the redeemed payload to the Actor.

### Redemption API

The following Java APIs support the redemption use-case above. These can be extended to support a custom redemption process.

redeemToken—Redeem the token as per the use-case defined above.

### Redemption Web Services

RedeemToken—this service supports the redemption process in the above use-case. On success the redeemed payload is returned.

### Identity Management

This component only manages basic account information. This includes a ‘display name’ that may be used for reporting purposes and default values for e-mail address and/or mobile that can be held as default values for the appropriate delivery channels. Users of the system authenticate themselves using a username/password. Calls to service based functions (web services) can authenticate via username/password or Certificate Based Authentication (x509.3). An administrator may register new users via a User Interface (UI)

### Identity Management API

The following Java APIs are exposed to the wrappers.

authenticateUser—authenticate a user's credentials and create a new session.
isSessionValid—returns true if the current session is still valid.
getSession—returns the current session which can be used to identify the user's account and other session details.
maintainAccount—create and maintain user account details.
hasRole—returns true if the current session has been assigned a particular role.

### Identity Management UI

The following user interfaces are provided for the identity management component.

Login—Basic login screen. Username/password authentication.
Error Page—A generic error page used to display authentication, page access and general error messages.
User Registration—This screen allows administrators to create accounts for new users and assign them an appropriate role.

### Reporting

The reporting component is responsible for the reporting functionality. Reports will be called from the administration screens and provide flexible reporting based on audit records written by the core components. Redemption reporting can report on both successful and unsuccessful redemption attempts. Successful redemption records include the date/time stamp, account, token type and optional location id if provided by the web service. Failed redemption attempts include date/time stamp, account, token type, optional location id if provided by the web service and information about the reason for the failure. Each token listed in the redemption report provides drill down functionality to get further information about the token. Reports can summarise the status of all tokens or a subset of the tokens as defined by parameters provided to the report. This report accepts dates, service and token type as parameters. A status summary report provides a drill down to get further information about the tokens in each status. A token report by status lists all the tokens in the given status that fall within the parameters passed to the summary report. It is possible to drill down on each token. The complete history of a token can be reported and a status summary report is available to report on the tokens associated with a batch.

The core reporting functionality does not include management information in the preferred embodiment. This is implemented on a wrapper-specific basis.

The reporting included as part of the core falls into the following categories:

### Audit Reporting

### Redemption Reporting

### Token Reporting

The audit reporting provides parameterised reports on the application audit table. This report may be parameterised based on a date or date range, the service, the audit level or the audit type. Each of these parameters is optional.

The redemption report provides information about successful redemptions and those that have failed. The redemption report may be parameterised based on the service, a date or date range and the token type. The report provides detail about the account and a ‘location id’ if provided by the web service. The failure report also includes any error codes that will provide further information about the reason for failure.

The token report lists a summary by status of all tokens within the system. This report has optional parameters of service, token type and date or date range. The token report by status provides information about the date the token was updated to the selected status and the account that requested the update. Each token will link to a token history report.

The token history report provides information on each status transition that the token has made. It will also report on the accounts that requested the transition, the date and any additional details that may have been supplied e.g. delivery channel, error code or location id. This report will include both successful transitions and transitions that have failed.

It will be appreciated that the reporting functionality available is highly advantageous as it allow tracking of tokens by the token creator. This may, for example, be the issuer of a money-off coupon who wants to track how many coupons have been issued and redeemed.

Audit Manager

The audit manager component handles audit requests. The core allows custom audit types to be defined (for use in a wrapper). Audit requests include an audit level. This allows the audit component to be configured to only record events within an audit threshold. All events associated with a token are audited and written to a token history. It is also possible to add a cryptographic seal to audit records, e.g. a digital signature produced using HSM, to provide evidence if the content of the audit record is modified.

Within the core components there are two types of auditing: Core Application Auditing and Token Auditing. The core application auditing allows audit records to be written for a range of actions. The actions that are audited are controlled at a service level. Each piece of audit information is categorised according to the Audit Type e.g. Login, UpdateReferenceData. Each Audit Type has an associated audit level. The level of audit required is associated with the service within the application reference data. Before an audit statement is written a check is made to see whether the audit record to be written has an audit level less than or equal to that defined for the service. Any audit record with an audit level in the correct range will be written to the audit able.

Each Audit Record will include the following information:

A date/timestamp indicating when the record was written;
Information showing the type of audit record that is being written and the audit level assigned to that information;
The service that the audit record has been written for;
An optional message—to store non-standard details;
Information about the account that triggered the writing of the audit record—this will always populated unless the audit record is for something like a failed log in.
A separate table is populated to support the token auditing requirements within the core application. Each time a token is created or a change is made to an existing table. A record is written to a table that records information about changes made to the tokens. This provides a complete history of the token life cycle for each individual token.

Each Token History Record includes the following information:

The id associated with the token that has been created or updated;
The account that created or updated the token;
A date/timestamp indicating when the record was written;
A short description from a list of allowable values that will describe why the record was written;
A flag indicating whether the record has been written after a successful update or a failure;
Any error codes returned by the application will also be included in the token history record if the creation/update of the token was a failure;
If an activate call is made the delivery method and detail values are populated to record the route via which the token was delivered;
If the validity dates of the token are changed the new dates will be recorded in the history record.

If an authentication or redemption web service call is received that includes information about the location where the web service has been called from e.g. a till id/store id/merchant id this is stored in the history record.

### Audit Manager API

writeAudit—create an application audit record.

The core and wrappers can create data that is auditable to the highest standards. This allows the system to provide non-repudiable data. This ability is integral to the reporting linked to unique identities represented by the TINs and their authentication path. It means that value based transactions can be safely performed whether the value is monetary or otherwise. However with true audit level data sitting behind the normal reporting modules, linked to the client's wrapper behind it) “transactional monetary Properties” can be safely associated with it. Therefore when an authentication and redemption of a VBT representing a coupon, ticket, voucher note etc is done it can be linked to a real monetary transaction such as a micro payment or some other form of banking system like money transfer. This gives clients the ability to do financial reconciliation in real time if they require. The level of security and trust in the entire system allows a client to make real financial links and account in the true sense. Thus the presence of non-repudiable data is highly advantageous. One aspect of non-repudiation is time of creation. Reliance on system time is not sufficient as it can be manipulated. Embodiments of the present invention enable a non-repudiable time stamp to be applied to VBTs which can be relied on.

### Security Manager

This component handles security within the core and preferably uses the Public Key Infrastructure (PKI). PKI is a set of technologies, standards and procedures that define an enterprise-level security infrastructure. Components of PKI include:

Secret (symmetric) keys
Public and Private Keys (asymmetric keys or KeyPairs)
Digital Signatures, which use Hashing algorithms and Message Digests

All cryptographic functionality may be implemented using the Java Cryptography Architecture (JCA) and Java Cryptography Extensions (JCE) APIs.

The security manager seals tokens with a MAC which can be validated by the core. A digital signature can be created for a token using a service's private key and can be validated by the core. The content of a token can be encrypted using a service's private key and the content can be decrypted. The core supports generation of true random numbers, e.g. to produce token Ids, and stores a token's credentials (PIN/password) securely, e.g. using cryptography to store a message digest generated from the credentials.

### Security Manager API

The following security commands will be provided via a java API. The API is built to allow new commands to be added as required without altering any existing API calls.

createMAC—creates a message authentication code using the key/algorithm defined for the service/token type.
validateMAC—validate a token's MAC using the key/algorithm defined for the service/token type.
encrypt—encrypt data using the key and cipher defined for the service/token type.
decrypt—encrypt data using the key and cipher defined for the service/token type.
createSignature—create a digital signature using the private key and cipher defined for the service/token
validateSignature—validate a token's signature.
createMessageDigest—create a message digest using a specified hashing function, e.g. to create a PIN hash.
generateTRN—generates a true random number.
applySecurity—apply a security policy to a VBT.

### Delivery Manager

The delivery manager enables messages (which may include a VBT) to be sent via different channels. The delivery manager is an extensible component allowing support for new channels to be developed and plugged in without modifying the interface between the wrappers and core and is shown in FIG. 6.

The core supports multi-channel delivery of VBTs which may, for example, include email delivery. A message template may be defined that will be used to deliver a token via a specific channel. Whenever a token is sent via the delivery service an audit record is written.

### Delivery Manager API

SendMessage—delivers a token via a specified channel using a template defined for the service/token type.

### Service Management

The token management component allows an administrator to create and maintain the reference data associated with a token. An administrator may create a service via a user interface (UI). The Service Management UI enables an administrator to assign supported token types to service, and to create and maintain service roles. The administrator can create and maintain token statuses and configure tokens to enable or disable the use of additional payloads.

A token status indicates whether redemption is possible and also indicates whether a token would pass authentication in this state. An operator may update token details in a batch, i.e. the same change is applied to multiple tokens for example, activating all the tokens in a batch. The core can support an extensible token lifecycle, making it possible to define new statuses and the valid transitions between statuses.

As there are a number of tables that need to be populated in order to configure the core components, there is a requirement to provide administration functionality to support updates to these tables. Administration functions and screens are only required for tables where the account holders or administrative account holders need to be able to make updates. A range of administrative functions is required to manage accounts within the core components. These functions allow for the creation of accounts and account maintenance. Whether these provide “self service” functionality or “administrator-only” functionality is determined at a wrapper level by the implementation of appropriate account types. These functions maintain the tables within the core component schema and also the basic information that will be held in the LDAP directory to support login functionality. All administrative changes that are made by application screens are audited using the appropriate audit types so that a full history of the changes made and the actioning accounts is maintained.

### Service Management UI

Administration Screens may provide for the following:

Service Configuration—this screen allows administrative users to update the audit_level, error_level and audit_method of the service. The service information screen also allows the security policy associated with the service to be updated.

Communication Templates—the screen allows templates (e.g. an email template) to be created and updated by users with the appropriate permissions.

Service/Account Mapping—a screen and/or API is provided to add new accounts to the appropriate service. An account must also be assigned an account type for each service to define the level of access the account holder has. The administration screen also allows for updates to the account type.

Account Types—A screen is provided to create account types and associate them with the appropriate roles to define their usage of the core components. The screen also allows administrative users to maintain the roles associated with account types.

Audit Types—A screen is provided to maintain the audit types available within the system in case any of the audit levels need updating.

Service Delivery Options—A screen is provided to maintain the delivery options that are available on a service-by-service basis. This screen will enable administrative users to switch delivery options on and off for the appropriate service.

Token Statuses—this screen allows administrative users to create and maintain token statuses.

Token Status Transitions—this screen allows administrative users to define valid transitions between token statuses.

Security Policy—this screen allows administrative users to define and maintain token security policies. These policies define the security

Update Token—Maintain existing token details, e.g. change status, end date etc. requirements used during token generation, e.g. should a digital signature be created, using which algorithm.

Reporting—menu access to the reporting homepage

The database used in the core may be any suitable database such as an Oracle 10g database.

The structure of the value based token (VBT) will now be described in more detail.

FIG. 7 shows the structure of the VBT. The token contains a contents portion 30 and a security portion 32. The contents portion 10 is divided into a header portion 34 and a payload portion 36. The header comprises a first data set DS1, and the payload contains a number of further data sets DS2-DSn−1. The security portion comprises a further data set DSn. Typically the header will contain a data set having at least three sub-data sets. The first 38 identifies the type of token. This is required in any open system in which the token could represent a number of different things such as an identifier for a medical prescription or an identifier for virtual money. The Token type data set identifies the nature of the token. The second data sub-set is a Token Identification Number (TIN) 40. The TIN is a unique number that identifies a particular token. The Third data sub-set is a PIN (Personal Identity Number) 42 and comprises a flag. Depending whether this flag is set on or off, the person presenting the token for redemption will be required to validate the token with their PIN number which will be compared with a number stored in the data set 42. The header section appears in all tokens whatever their application. It uniquely identifies a token and indicates whether the token is PIN protected. Thus the header content is:

| | |
|---|---|
| header: | <type><tin><pin flag> |
| Type: | Identifies the type of VBT (5 digits) |
| Tin: | Unique VBT Identifier (16 digits) |
| Pin flag: | Flag indicating pin requirement (1 digit |

Preferably, the header is not encrypted. This is important in an open system in which the token type must first be read before a decision can be made as to what token type it is and, therefore, how it should be processed. The header, therefore contains information about the token itself.

The payload will vary depending on the nature of the token and its application. It contains information, which is related to the use to which the token is to be put. In order to reduce the data content, and thus to enable the VBT to be encoded in a relatively small data carrier such as a data matrix, the actual data need not be stored in the payload. Instead an identifier is stored which, when read, enables data associated with that identifier to be retrieved from a database. Thus, for example, the database at the core/wrapper or elsewhere may store the bank account number, cheque number and sort code number of a cheque, together forming a bank identity. The payload merely holds data, such as an address that is sufficient to retrieve this bank identity from the database. The payload may be encrypted but it will be appreciated that the system is inherently secure as the information stored in the payload is meaningless, even when decrypted, without access to the database.

The content of the payload is specific to a wrapper and may even be omitted in some applications. The payload may comprise a plurality of data sets. In the description of the core above, these may comprise one or more datasets that are an additional payload and may be a reference to data or relational structures that are stored elsewhere, for example in the core repository. Each data set may be intended for a different purpose, for example for a different party or service.

Thus, the content part of the Value Based Token comprises a header data set which contains data about the token itself which may be unencrypted and may be divided into a number of sub-data sets; and a payload data set which may be encrypted and which contains a reference to data relating to the subject of the token enabling that data to be retrieved.

If the token's security policy specifies that the payload is encrypted the cipher (encrypted text) will be stored in the payload. Due to the binary nature of encrypted data it will be base encoded before storing it in the VBT. One suitable encryption algorithm is the AES symmetric algorithm for encryption of payload content. Thus:

Payload content: <free text>|<cipher text>

The security mechanism 32 will vary according to the intended use of the token and the type of data carrier on which is encoded. The security mechanism is a cryptographic fingerprint and protects the payload and header from tampering and counterfeiting. For example, the security mechanism may comprise a SHA 256 Hash or an RSA Digital Signature. A Hash has the advantage of being small in size and fast, whereas a digital signature is larger and slower, but more secure. The appropriate security mechanism will depend on the use to which the token is being put and the degree of security required. For example, a token which represents a small discount on an item form a supermarket will require much lower security than a token that represents personal cash or a cheque.

Thus, the content and size of this section is determined by the security profile defined for the token type and the key strength used in security algorithms.

Security content: [<message digest>|<signature>]

Message Digest: If the security policy specifies a hashing algorithm, the message digest is produced by the hashing the <header> and <payload>.

Signature: Where a signature is specified in the security policy the <header> and <payload> sections will be hashed and the resulting message digest signed with the service's private key to generate a digital signature. Due to the binary nature of message digests and digital signatures values will be base encoded before storing in the VBT.

It follows from the foregoing discussion of the core and the wrapper that the core defines the structure of the VBT and that the core also preferably defines the header and the security portions. The wrapper for that application may define the payload contents, which are specific to each application. Thus the syntax and semantics of the header and security portions are defined in the core as well as the supported encryption algorithms for the customer payload. The complete VBT is stored in the core but the payload is defined and constructed in the wrapper. If the payload contains references to other data or relational structures, for example due to capacity constraints of the data carrier, these too will be defined in the wrapper.

FIGS. 8 and 9 show how different VBTs can be constructed, depending on the application and the data capacity of the data carrier. FIG. 8 shows a data heavy VBT and FIG. 9 a data light VBT. In FIG. 8, the payload contains 1 or more data sets which, when read, are routed through a local data set router 100 which communicates with the system server 102 to authenticate the token TIN and routes the payload data sets to different end points. In the example of FIG. 9, there are three data sets in the payload: DS2, DS3 and DS4. DS2 is routed to a local authentication points such as a till, DS3 is routed to a marketing department and DS4 is routed to some other end point. An individual data set may be routed to more than one point, and the data in the data sets may have a degree of overlap.

In the FIG. 9 case, the VBT is data lite and comprises a header and a security section only. The payload is stored at the core server and referenced by the TIN in the header. In an alternative, not shown, the payload could include a data set that is a reference to data or relational structures stored elsewhere.

FIGS. 10 and 11 show intermediated cases where the payload carries some actual data but also references data stored elsewhere. In FIG. 10, the payload includes data sets 2 and 3. A fourth data set is stored at the wrapper database are is pulled when the TIN is provided for authentication. In the FIG. 11 example, one or more of the data sets in the payload is linked to supplemental data, shown as stored at the wrapper database. Thus, the TIN references the data sets and the supplemental data. This again reduces the amount of data that needs to be carried in the VBT.

FIG. 13 shows the lifecycle of a VBT. A token may exist in a number of states: Created, suspended or redeemed. A change in status may occur through the activities of activation, cancellation or authentication.

The content of the VBT depends not only on the intended use of the token, but also on the nature of the data carrier that is going to be used to carry the VBT. Many types of data carrier are available. The data carrier is a portable data transport medium and, must be capable of storing identity data string components. A data carrier is usually a type of barcode or RFID device.

The data transport is constructed to have the generic format of the VBT:

| | | |
|---|---|---|
| Header | Payload | Security |

By using a common VBT for all applications, the common format and approach can be adopted even though different markets and applications have different requirements on how to place ‘identity’ data (or portable credential) onto an item and what that data item must include. For example, the level of security used may vary from minimal to very high. This has an implication on the amount of data that must be held in the data carrier and, in turn, what data carrier is appropriate. At one extreme, the VBT may have just a header and a security portion having low security. At another extreme, the VBT may include high security and a payload having several data sets each including a large amount of data. In between these extremes, the payload may have one or more data sets one or more of which may comprise a reference to data stored elsewhere.

Existing 1D barcodes (for example EAN 13 and EAN128) and 2D symbologies need may be used. Examples are QR code and Maxi code, and the Data Matrix (DMx). PDF 417 barcodes, RSS (Reduced space symbology) codes and RSS Composite (1D plus 2D) may also be suitable.

Embodiments of the invention may be used in environments in which a chosen Data Carrier is already used, whether it is a printed or marked barcode or a RFID type carrier. This pre-existing barcode type may be required for the solution as already have printing devices and scanning technology. In some cases, the VBT may be added to existing data carriers, such as a carrier used by a customer for other purposes. This is particularly possible on RFID devices which have a relatively large storage capacity but may also be possible on other carriers.

It is possible to create hybrid data from the actions and status of a client or consumer, for example by updating information and/or the data sets to create a new VBT either on the existing or a new data carrier. How the new hybrid VBT is sent to the data carrier depends on the Wrapper but follows the same route for its predecessor but may occur at a different place. In a particular solution user Rules may be require the first carrier to be scanned again before the second is scanned providing a two part verification process building a authentication picture. This is desirable, for example, in a ticketing situation. For a coupon the new VBT may be an update of where a customer had used the coupon and what status had changed, ready for the coupon to be used again. In this context a receipt printed at a till could easily print out a new carrier.

Table 1 below shows a number of examples of data carriers that may be suitable for use with embodiments of the present invention, depending on the requirements of the application.

TABLE 1

1D Barcode type
(traditional range) eg EAN 13 or 128
Data Matrix
(ISO/IEC standard 16022)
QR Code
(ISO standard 18004)
PDF 417
(ISO standard 15438 - June 2001)
Maxi Code -
Vericode
RFID-all types
(including Gen 2) also known as Radio Barcodes)
CHIP -

Thus, the VBT is first created and holds the final identity output created in the system core before it is encoded onto the data carrier of choice. The VBT has header, payload and security components as specified in the wrapper that is specific to that application. Encoding the data into/onto a Data Carrier will not alter the information of the original VBT data string. Therefore in the example of the DMx it would turn the VBT into a DMx image which when scanned would translate back into the original VBT content. In an example of RFID the VBT would be onto the RFID tag.

It is preferred to optimise all data to suit the data carrier type. This may involve using specific character sets or Base encoding to reduce unnecessary content overhead such as encountered when creating a DMx. Some data carriers have specific input formats.

In some applications, the data carrier will be held by a third party. An example is a manufacturing company who have their own data carrier (DC) generating software. A DC output can be an image or more common to a font generator so is treated like text. The font must be installed on the processing machine to see or print the image. The VBT may be sent out raw from the system for encoding by the customer.

When the system described serves a Data Carrier output, for example a DMx, it needs to suit the client's requirements. If a client has different delivery channels: mobile, print via web, print to print company, print to marking technology etc. then the solution must be able to serve the optimal output for that channel. This is relevant to all 1 D barcode and 2D symbologies where if an output is to an image format rather than a “font” then the physical size, dpi or pixel size has to be considered and matched to the requirement. In an example where a consumer could choose from a range of options to collect his coupon such as phone, home print etc, kiosk the system is able to create specific graphic outputs.

In one embodiment of the invention, more than one type of carrier output may be provided. For example, an RFID tag may be used with a traditional printed barcode. In that case, the system may supply two identities: the DMx and RFID information. These identities may be the same but allow for different scanning routes. In one embodiment of the invention, where a single DMx, or other chosen data carrier, is not able to contain all the data or where 2 identities need to be issued to a single item (containing different information or for different uses), then two or more data carriers may be issued.

FIGS. 8 to 11 also show how a data carrier with an encoded VBT may be read. The data carrier is first scanned to recover the VBT. The header in the VBT is not encrypted and from this the scanner, shown as the VBT Parser can determine the nature of the VBT. For example, it may identify the VBT as a coupon, a cheque, a ticket etc. This may affect the way in which the recovered VBT is processed. In FIG. 8 the VBT is constructed as data lite, which means that there is no payload. The TIN in the header is used to authenticate the wrapper and is used to access data sets that are stored elsewhere. In FIG. 9, the VBT is data heavy and the datasets are in the VBT payload. Thus, in FIG. 8, the VBT is recovered by the VBT parser, which sends an authentication request including the header and cryptographic fingerprint data sets to the authentication service. The TIN is recovered and compared with the TINs stored in the core repository, and if there is a match and authentication confirmation is sent to the parser as described above. In addition, data that is associated with the TIN, which is shown stored in a wrapper repository, but which could be elsewhere. This data comprises one or more data sets and may comprise data that is in the payload in the data heavy example. These data sets are pulled by a data set router and distributed to one of a number of recipients. As shown in FIG. 8, different recipients may receive different data sets although it is possible for each recipient to receive any or all of the data sets. In the FIG. 9 case, the data sets stored in the wrapper database in FIG. 8 are already part of the VBT and are pushed by the client data set router to their intended destinations.

The data-lite model for the VBT shown in FIG. 8 enables discretionary (DAC) and mandatory access controls (MAC) to be placed on the content referenced by the TIN in the core database. Discretionary access controls are generally granted by a person such as the object owner and determine read and write access privileges to the object to users and groups of users. Mandatory access controls are enforced by the operating system or database and protect classified data that has been protectively marked or labeled from being inappropriately accessed or disseminated to those with insufficient security clearance. This is a multi-level secure (MLS) implementation of core suitable for Government applications such as a National Identity card scheme.

For a VBT that represents the identity of a person in the form of a serial number, this scheme can be used to control the type of information that is returned about that person. In order to implement this level of control the core database needs to know who is making the request; what role the person is fulfilling; and the location from where the request is being made. This identity based information can be obtained from an X509 certificate identifying the client making the information request. The client is a trusted node in the network with a pre-defined security clearance.

The manner in which a data carrier may be presented to a user may vary according to the application. For example, where the VBT represents a coupon for redemption in a supermarket or other store, the user will access the website of the supermarket or a particular supplier or manufacturer and be able to download the coupon. This will involve a VBT being generated and encoded onto the data carrier as described above. The user can then print the coupon including the data carrier a present it for redemption at the supermarket checkout. Alternatively, the coupon need never be printed but may remain in electronic form for redemption against electronic purchases.

Thus embodiments of the invention use a value based token which is encoded onto a data carrier. The VBT comprises a clear header, a payload, which may be encrypted, and a security section. The header is a data set which allows the VBT to be identified and may comprise a number of sub-data sets. The payload is a further data set, which contains information, which allows a reader access to data. The payload could be split provided that the reader is able to distinguish between two different data sets. As the payload does not contain actual information about the token, but a pointer to where that information is stored, the security of the token is improved. Moreover, the token is far more flexible that prior art examples which are limited by the ability of the data carrier, such as a data matrix or bar code to carry information. As the information about the token is not actually held in the payload, this problem is avoided.

The VBTs are generated, stored, authenticated and redeemed by a system, which comprises the core and one or more application specific wrappers. This approach provides a system, which can generate tokens for a wide range of applications with all common operations being performed by the core and application specific operations performed by the application wrapper. Thus, different data carriers may be used, or different payload structures used without affecting core operations. This is highly advantageous.

FIG. 12 shows how cryptographic functions are handled. All cryptographic functionality may be implemented using the Java Cryptography Architecture (JCA) and Java Cryptography Extensions (JCE) APIs. The cryptographic functionality within the core may use nCipher's netHSM Hardware Security Module (HSM). The netHSM is a FIPS 140-2 Level 3 validated security boundary, i.e. a proven certified security boundary meeting cryptographic best practice. As shown in FIG. 16, the HSM is accessed using nCipher's JCE provider implementation (nCipherKM JCA/JCE CSP) to perform encryption, decryption, key generation etc. Other JCA/JCE providers could be used.

FIGS. 14 and 15 show an example of how the core and wrapper may be configured in a specific example of a cheque clearance process in which the VBT encoded on a data carrier is placed on a bank cheque. The system embodying the present invention comprises the core and the application wrapper shown in FIG. 13. This must integrate with a customer's existing systems by means of integration software. The various functions of the integrations software, the wrapper and the core are shown in FIG. 15. The functions of the core were described above and will not be described and further. The wrapper creates individual cheque identities on the basis of information provided from the bank computer systems. These are not the same as TINs. A TIN identifies a particular VBT whereas the cheque identity is the identity of the cheque to which the data carrier bearing the VBT is applied. The wrapper passes the identity information to the core and also acts as an intermediary between the bank system and the core for the distribution of cheque identities, authentication, reporting and administration. Thus the cheque identities created by the core are passed to the bank system to be encoded onto a data carrier and placed on the printed cheque. The authentication process involves the bank communicating with the core via the wrapper, typically by a secure IP based network or virtual private network. When the customer presents a cheque, the bank branch will make an authentication request. In the clearing process, the collecting bank clearing centre will authenticate the cheque and then the paying bank will authenticate the cheque. After both sides have authenticated, further checking, fraud detection and cheque profiling may be used to complete the clearing process. In addition, the bank back office systems may communicate with the core via reporting and administration modules in the wrapper for administrative and reporting purposes.

FIG. 16 shows a further application of embodiments of the invention. In this case, the VBT carries retail coupons, which are generated by manufacturers or retailers, for example having a monetary value, which can be redeemed on presentation of the coupon when buying a ticket. It demonstrates how the solution may fit into a managed coupon campaign. This implementation is complex and involves integration with several third parties, including the coupon campaign promoter which generates and distributes coupons to targeted consumers via web, direct mail and Mobile; the retailer POS which scans and accepts coupons encoded in 2D barcodes or other data carriers over the counter and perform basket matching to prevent mis-redemption; an authentication backbone provider which may, in practice, be a network that is presently used to authorise chip & PIN credit card transactions; a settlement house for settling coupon transactions using micro payments whereby the retailer gets paid directly by the manufacturer; and a retailer back office which administers and reports on coupon campaigns. In this example, the coupon management system is responsible for generation of coupons and for distribution of them through conventional coupon distribution channels such as direct mail, Internet and mobile telephony. The coupon management system sends details of the coupon to the core via the coupon wrapper and a pre-defined number of uniquely identified coupons are generated and stored in the core repository. At coupon distribution, the wrapper interacts with the core to extract coupon identities to form the coupons into VBTs having the correct structure and content for this application and to provide them to the coupon manager to be encoded onto the preferred data carrier for the distribution channels selected. When a customer produces a coupon for redemption, the coupon, will carry the data carrier having the VBT encoded thereon. The core via the authentication and redemption functionality of the wrapper, can authenticate the VBT. Similarly to the cheque example above, the wrapper can communicate with retailer back office functions to provide reporting and administration functions.

FIG. 17 shows the coupon process flow from the point of view of basket reconciliation by a retailer. The customer will come to a check out till 200 with a basket of goods 210 such as groceries that are to be scanned and one or more coupons 220 which the customer considers represent discounts on one or more of the items in the basket. At the point of sale (POS) 230 a POS scanner will scan the goods in the basket at 270. The POS scanner will comprise hardware and software 240 and a communications link 250 to a back office together with an EPOS Link 260 allowing for online payment. After scanning, the total value of the shop is determined at 280 and the payment process initiated at 290. The customer will produce their coupons and other vouchers as part of the payment at 300. The coupons may include retailer loyalty vouchers 310 and retailer specific coupons 320 as well as manufacturer specific or item specific coupons. The coupons may be in the form of conventional coupons 340 or coupons 330 that carry a data carrier encoded using embodiments of the present invention as discussed above.

The coupons 330 that include a data carrier are scanned at the POS till. Local checks may be made, for example a visual inspection at 350 that the coupons relate to goods that have been presented for payment. Some, all or none of the coupons may pass this inspection (360). Coupons that fail will be rejected (at 370). Coupons that pass this stage are ready for authentication at 380, this may be by offline or online processing and may be performed on a batch by batch basis in which case the scanned data is batched at 390. It will be appreciated, therefore, that only pre-reconciled coupons are authenticated. In the example given this pre-reconciliation is visual but it may be performed by other means such as electronically. In one embodiment, the VBT payload includes a data set which identifies the item. This can be retrieved locally when the coupon is presented by the customer and reconciled against the actual items scanned by the POS till. If the items match, the coupon relates to the item that has been presented for sale and can then be sent for authentication. At this stage, the check merely finds that the coupon relates to an item which is being purchased. It does not indicate that the coupon is authentic and valid. The online authentication processing is performed at 400 and comprises communicating the retrieved VBT to the authentication server for authentication 410 as described above. This may be done online via POS to a back office (420) or online via EPOS via a banking network (430). Following authentication, those coupons that have been passed are communicated back to the checkout till at 440 where the value represented by the tokens can be deducted from the running total of the shop to provide a fresh running total 450 which can be settled by a payment by the customer at 460.

The offline processing is shown at 500. Here, the authentication is performed locally by the retailer who checks that the coupon is authentic and live. A local database is supplied with the VBT data from the core repository and the authentication check is made against that local copy. Although this method does not have a lot of the functionality of the system as described above, it may be suitable in some circumstances, for example for low value coupons, where the retailer does not wish to perform online authentication.

FIG. 18 shows an embodiment of the present invention used for authentication of tickets. In this example, a data carrier encoded with a VBT as described above is applied to a ticket, for example an event ticket or a travel ticket. The event holder is illustrated generally at 510 and generates details of events that are being held for which tickets can be purchased. The Event holder 510 will include a repository of event data and a website solution interacting with an event server, an event administration module and a box office. The website solution provides event data to a website 515 which can be accessed by consumers 520. As with any on-line ticket booking system, the consumer will be able to select the events they wish to attend and the dates, times, seating areas etc. Once the selection has been made the consumer pays for the tickets in a normal manner. However, the website communicates with the authentication system described above and, retrieves, via the wrapper for the application, the VBT for that ticket which is encoded on a data carrier and provided to the consumer at their web browser. The consumer can then print the ticket with the data carrier for subsequent use. At the venue 530, the consumer produces the ticket that they have printed to gain admission at which point the data carrier on the ticket is scanned to retrieve the encoded VBT. The TIN can be retrieved from the header and sent to the authentication server 540 to be compared with the TIN stored in the database. Additionally, and depending on the manner in which the wrapper populates the payload, the authentication server may release to the venue other data which has been stored for that VBT at the database. Alternatively, that information may be contained in one of the payload data sets. This, for example, may be name and address information for the ticket holder which can than be validated manually at the venue on production of identification by the ticket holder.

One particular advantage of the systems described above, whatever the wrapper application, is the ability to change the status of tokens through administration and management functionality within the core and a wrapper to reflect events and activities. In the example of coupons given above, this may be for reasons of stock control or oversubscription of a promotion. The status may change by ‘turning off’ the coupons so that they can no longer be redeemed, and passing on an associated message to the point of presentation. This can be applied to a single coupon or multiple coupons or all outstanding coupons.

In one preferred embodiment, different data sets on the VBT payload represent different statuses of the token. Thus, for example, data in or represented by a first payload dataset may be used when the VBT is in one status and data in a second payload data set used when the VBT is in a second status.

The core can audit date and time making it possible to set coupons that have different values depending on a data and time range. In the ticketing example, date and time may be used to determine the authenticity of the ticket.

A single data carrier such as a data matrix may represent a number of tokens. In the coupons example, a single carrier may represent a sheet of coupons. This is particularly advantageous where the coupons are available to customers online. In the retail environment several product coupons could be embedded into one data matrix saving time while scanning.

As mentioned above, the header includes a flag for a PIN. In some situations the customer may add a PIN as part of the VBT creation. In other situations the provider or the originator would specify the PIN and distribute it as appropriate. The pin may be used as a way of enabling the unlocking of one or more of the data sets.

In the foregoing description, the term value based token has been used. For the avoidance of doubt, A VBT can represent the identity of a product, item or person. The concept of value here need not necessarily be financial, but represents a unique identity to which a value or status can be attached. It can be, for example, a retail coupon, a ticket, a non-repudiable ID sealing a document or transaction.

Various modifications to the embodiments described are possible and will occur to those skilled in the art. The invention is limited only by the scope of the following claims.

1. A system for generating and authenticating tokens representing value, comprising:
a core system for generating and authenticating tokens; and
a plurality of application specific wrappers communicating with the core system each for providing the core system with application specific data relating to tokens generated by the core, whereby the core produces tokens which have a content controlled by the wrapper; and wherein the core comprises:
a token generator responsive to one of the wrappers for generating value based tokens having parameters at least partially determined by the wrapper;
a store for storing the value based tokens;
an encoder for encoding the value based tokens onto a data carrier, the encoder being responsive to the wrapper to determine the encoding applied by the encoder; and
a token deliverer for delivering the generated tokens electronically to third parties via a delivery channel.

2. A system according to claim 1, wherein the delivery channel is selected by a wrapper.

3. A system according to claim 1, wherein the token generator creates a token in response to a request from the wrapper.

4. A system according to claim 1, wherein the token generator modifies a token in response to a request from the wrapper and stores the modified token in the store.

5. A system according to claim 1 wherein the encoder retrieves a token from the store for encoding according to a format specified by the wrapper.

6. A system according to claim 1, wherein the data carrier is a 2-dimensional bar code.

7. (canceled)

8. (canceled)

9. A system according to claim 1, wherein the toke generator comprises a token manager which receives a token type from the wrapper, generates a token identification number, and creates the token in the store.

10. A system according to claim 9, wherein the token manager receives further token attributes from the wrapper.

11. A system according to claim 10, wherein the further token attributes are at least one of a PIN code, data to be carried with the token, token start date, token end date, token status, and the number of times the token can be redeemed.

12. A system according to claim 9, wherein the token manager generates an internal token key for each token, the internal token key being used to reference the token identification number (TIN) when the TIN is received from a remote location for authentication.

13. A system according to claim 9, wherein the token manager retrieves a security function for the token type and applies the security function to the token prior to storage.

14. (canceled)

15. A system according to claim 1, wherein the encoder receives a request from the wrapper including the token identification number and the type of data carrier, and wherein the encoder returns the data carrier encoded with the token to the wrapper.

16. (canceled)

17. A system according to claim 1, wherein the core comprise a token authenticator for authenticating the validity of tokens received from the wrapper.

18. A system according to claim 17, wherein the authenticator receives the token TIN, confirms that the token exists in the store and authenticates the token if the token is stored as valid.

19. A system according to claim 18, wherein the token has a start and end date and authenticator further validates start and end dates.

20. A system according to claim 19, wherein the token has a redemption count indicating the number of times it can be redeemed and the authenticator validates the token only if the redemption count has not been exceeded.

21. A system according to claim 17, wherein the authenticator retrieves the security profile for the token and validates the security content of the token.

22. A system according to claim 17, wherein, the core further comprises a redemption component for redeeming authenticated tokens, the redemption component changing the status of a token in the store to indicate that it has been redeemed.

23. A system according to claim 22, wherein the redemption status is changed by incrementing a redemption count.

24. A system according to claim 1, wherein the token is a value based token having a header including a token identification number, a payload and a security section.

25. A system according to claim 24, wherein the payload includes an additional payload comprising a reference to data stored in the store which is provided on authentication of the token,

26. A system according to claim 25, wherein the payload and additional payload are data sets that are readable independently of each other.

27. A system according to claim 1, wherein each token has a non-repudiable time stamp associated with it on creation.
